(19) United States
(12) Patent Application Publication
(10) Pub. No.: US 2007/0296186 A1
(43) Pub. Date: Dec. 27, 2007

(54) CUSHION OF AIR BAG SYSTEM

(75) Inventor: Hae Wook Kwon, Yongin-si (KR)

Correspondence Address: GREENBLUM & BERNSTEIN, P.L.C., 1950 ROLAND CLARKE PLACE, RESTON, VA, 20191, US

(73) Assignee: HYUNDAI MOBIS CO., LTD., Yongin-shi (KR)

(21) Appl. No.: 11/466,553

(22) Filed: Aug. 23, 2006

(30) Foreign Application Priority Data
Jun. 23, 2006 (KR) 10-2006-0056755

(51) Int. Cl. B60R 21/233

(52) U.S. Cl. 280/729

(57) ABSTRACT

A cushion of an air bag system is provided. The cushion of the air bag system includes a first cushion deploying by a gas of an inflator, a second cushion formed in front of the first cushion to receive the gas from the first cushion and to deploy toward a rider, and a cushion connecting unit formed between the second cushion and the first cushion so that the second cushion is rotatably connected to the first cushion and that the internal gas of the first cushion flows into the second cushion. It is possible to prevent the rider in the OOP state from being injured and to secure the performance of protecting the rider in the normal position state. During the test of the performance of protecting the one year old child, the three year old child, and the six year old child in the OOP state of the air bag system, the injury reduction deployment of the cushion is satisfied. Since the passenger recognizing sensor and the plurality of flaps are omitted, it is possible to reduce the number, the cost, and the weight of parts of the air bag system.

This nonprovisional application claims priority under 35 U.S.C. § 119(a) on Patent Application No. 10-2006-0056755 filed in Republic of Korea on Jun. 23, 2006, the entire contents of which are hereby incorporated by reference.

### BACKGROUND OF THE INVENTION

1. Field of the Invention

The present invention relates to a cushion of an air bag system for protecting a passenger against a shock during the collision of a vehicle, and more particularly, to a cushion of an air bag system for minimizing an injury inflicted to a passenger in an out-of-position (OOP) state.

2. Description of the Background Art

In general, an air bag system is provided in a vehicle in order to absorb the shock applied to a passenger who rides in a driver's seat or a passenger seat during a collision accident to prevent the passenger from being injured.

The air back system includes a driver's seat air bag system, a passenger seat air bag system, and a side air bag system. The driver's air bag system is mounted in a handle to protect the front side of the driver. The passenger air hag system is provided in an instrument panel to protect the front side of the passenger in the passenger seat. The side air bag system is provided on the side of the seat to protect the side of the rider.

The air bag system includes an inflator for discharging a gas during the collision of a vehicle, a cushion that deploys toward the rider by the pressure of the gas of the inflator to absorb the shock applied to the rider, and an air bag housing in which the cushion and the inflator are accomodated to be provided in the vehicle.

In the air bag system, the gas discharged from the inflator during the collision of the vehicle is flown into the cushion and the cushion deploys toward the rider by the pressure of the gas so that the shock applied to the rider by the collision of the vehicle is absorbed.

A gas inlet into which the gas of the inflator is flown is formed on the opposite side of the rider of the cushion. At least one tether for controlling the shape in which the cushion deploys is provided in the cushion.

However, in a conventional cushion of an air hag system, in an out-of-position (OOP) state where a rider is abnormally seated in a seat of a vehicle, the rider is not protected by the deployed cushion and the rider is more injured by the deployment pressure of the cushion.

Therefore, in a recent air bag system, a passenger monitoring sensor for recognizing the state in which the rider is seated is provided in a vehicle so that, when it is recognized that the rider is in the OOP state by the passenger monitoring sensor, the cushion does not deploy or the cushion low risk deploys to prevent the rider from being injured.

In order to low risk deploy the cushion, the gas pressure of the inflator is reduced, the gas flown into the cushion is a lot discharged to the outside at an initial stage of the deployment of the cushion, and the initial deployment of the cushion is guided by an additional structure.

However, in a method of reducing the gas pressure of the inflator or discharging the gas flown into the cushion to the outside at the initial stage of the deployment of the cushion, a performance of protecting the rider in the OOP state of the air bag system is secured, however, a performance of protecting the rider in a normal position state of the air bag system deteriorates.

Also, in a method of arranging a plurality of flaps outside the cushion to surround the cushion and to overlap each other so that the initial deployment of the cushion is delayed by the friction resistance along the flaps, a performance of protecting the rider in the OOP state of the air bag state is secured. However, since the friction resistance among the flaps is not uniform, it is very difficult to uniformly design the performance of the air bag system. According as the plurality of flaps is added, the structure of the cushion becomes complicated, cost increases.

Recently, the performance regulations of the air bag system tend to be reinforced so as to protect the rider in the OOP state, in particular, the performance of protecting the riders such as a one year old child, a three year old child, and a six year old child in the OOP state is stipulated. When the performance regulations are not satisfied, a business is under disadvantage.

According to the above-described air bag system, it is possible to secure the performance of protecting the six year old child whose body shape is similar to that of an adult in the OOP state. However, it is difficult to secure the performance of protecting the one year old child and the three year old child whose body shapes are a lot different from that of an adult in the OOP state.

### SUMMARY OF THE INVENTION

The present invention has been made in an effort to provide a cushion of an air bag system in which the cushion is composed of first and second cushions so that the first cushion is first deployed and then, the second cushion is deployed and that it is possible to prevent a rider in an out-of-position (OOP) state from being injured and to secure a performance of protecting a rider in a normal position state.

The present invention has been made in an effort to provide another cushion of an air bag system in which the cushion is deployed so that a ride in an out-of-position (OOP) state from being injured and that a passenger recognizing sensor and a plurality of flaps are omitted to reduce the number of parts, the cost, and the weight of the air bag system.

According to the present invention, there is provided a cushion of an air bag system including a first cushion deploying by a gas of an inflator, a second cushion formed in front of the first cushion to receive the gas from the first cushion and to deploy toward a rider, and a cushion connecting unit formed between the second cushion and the first cushion so that the second cushion is rotatably connected to the first cushion and that the internal gas of the first cushion flows into the second cushion.

The first and second cushions and the cushion connecting unit are integrated with each other. The cushion connecting unit is formed by partially sewing the connecting part of the first and second cushions.

Gas floating paths whose sections are narrower than the sections of the first and second cushions are formed in the parts that are not sewed in the cushion connecting unit. Vent holes for discharging a gas to the outside are provided on both sides of the second cushion.

The cushion includes a main panel for forming the front part, the rear part, the upper part, and the lower part of the cushion and a pair of side panels connected to the main panel to form the left side and the right side of the cushion. The cushion connecting unit is formed by partially sewing at least one panel of the intermediate parts of the main panel and the side panels.

The cushion connecting unit includes sewing units for sewing one side of the intermediate part between the upper part and the lower part and orifice units formed on the other side of the intermediate part between the upper part and the lower part to function as gas floating paths.

The plurality of sewing units may be provided from side to side and the orifice units may be formed between the pluralities of sewing units. The plurality of sewing units may be provided back and forth and the orifice units may be longitudinally formed back and forth by the plurality of sewing units.

The intermediate part of the lower part may he bent to protrude upward to be attached to the intermediate part of the upper part, the intermediate part of the upper part may be bent to protrude downward to be attached to the intermediate part of the lower part, or the intermediate parts of the upper part and the lower part may be bent to protrude downward and upward to be attached to each other The sewing parts are provided in the attached parts of the upper part and the lower part.

Unlike the above, the cushion connecting unit may include sewing units for sewing one side of the intermediate part between the left part and the right part and orifice units formed on the other side of the intermediate part between the left part and the right part to function as gas floating paths.

### BRIEF DESCRIPTION OF THE DRAWINGS

FIG. 1 is a sectional view illustrating a passenger seat air bag system according to the present invention;

FIGS. 2A to 2C are side views illustrating various shapes of a cushion of a passenger seat air bag system according to an embodiment of the present invention;

FIG. 3 is a view illustrating the section taken along the line A-A of FIG. 2A;

FIG. 4 is a perspective view illustrating the cushion of FIG. 2A;

FIG. 5 is a perspective view illustrating a cushion of a passenger seat air bag system according to another embodiment of the present invention;

FIG. 6 is a sectional view illustrating the cushion connecting unit of FIG. 5;

FIG. 7 is a perspective view illustrating a cushion of a passenger seat air bag system according to still another embodiment of the present invention;

FIG. 8 is a perspective view illustrating a cushion of a passenger scat air bag system according to still another embodiment of the present invent i on: and

FIG. 9 is a sectional view illustrating the cushion connecting unit of FIG. 8.

### DETAILED DESCRIPTION OF EMBODIMENTS

The present invention now will be described more fully with reference to the accompanying drawings, in which embodiments of the invention are shown.

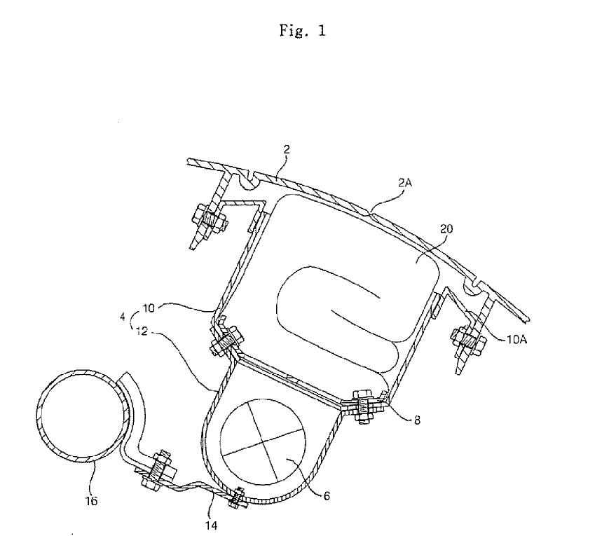

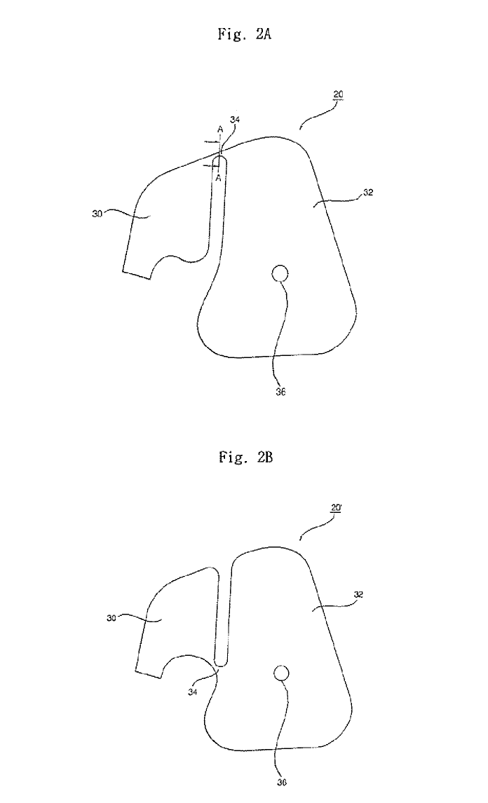

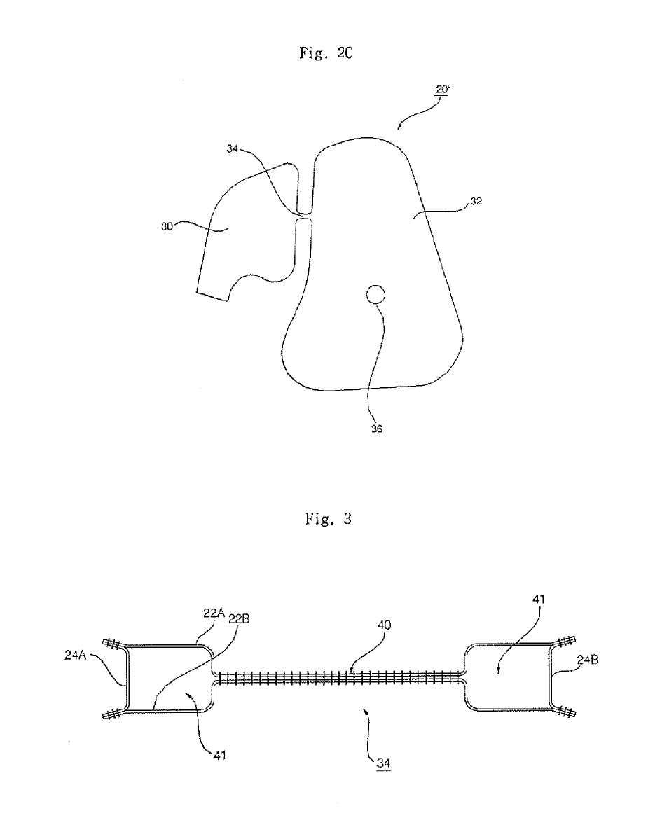

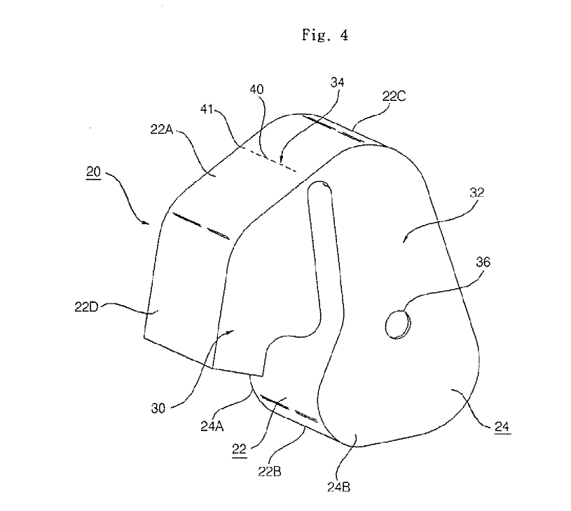

FIG. 1 is a sectional view illustrating a passenger seat air bag system according to the present invention. FIGS. 2A to 2C are side views illustrating various shapes of a cushion of a passenger seat air bag system according to an embodiment of the present invention. FIG. 3 is a view illustrating the section taken along the line A-A of FIG. 2A. FIG. 4 is a perspective view illustrating the cushion of FIG. 2A.

As illustrated in FIG. 1, the passenger seat air bag system according to the present invention includes an air bag housing 4 provided in an instrument panel 2, an inflator 6 provided in the air bag housing 4 to discharge a gas during the collision of a vehicle, a retainer 8 fixed to the inside of the air hag housing 4 and having a plurality of holes for discharging the gas of the inflator 6, and a cushion 20 accommodated in the air bag housing 4 to deploy toward a passenger seat by the gas discharged through the holes of the retainer 8.

The air bag housing 4 includes a cushion housing 10 that is mounted on the back of the instrument panel 2 and the inside of which that cushion 20 is accommodated and a can housing 12 that is provided in the rear part of the cushion housing 10 and the inside of which the inflator 6 is accommodated.

A flange 10A is formed on the external surface of the cushion housing 10 to be fastened and fixed to the instrument panel 2 by bolts. A mounting bracket 14 is formed on one side of the can housing 12 to be fastened and fixed to a cowl cross member 16 by a bolt.

The inflator 6 is connected to a collision recognizing sensor (not shown) for recognizing the collision of the vehicle to be inflated by the signal of the collision recognizing sensor during the collision of the vehicle and to discharge a high pressure gas.

The cushion 20 is accommodated in the cushion housing 10 in a state of being folded a plurality of times in the cushion housing 10 so as to deploy forward the cushion housing 10 by the gas pressure of the inflator 6.

The cushion 20 is composed of a vessel shaped main panel 22 whose left side and right side are opened to form the front part 22A, the rear part 22B, the upper part 22C, and the lower part 22D of the cushion 20 and a pair of side panels 24 sewed on the left and right sides of the main panel 22 to form the left part 24A and the right part 24B of the cushion 20.

The main panel 22 and the side panels 24 are formed of a fabric to be sewed so that they are combined with each other.

According to the passenger seat air bag system having the above structure, when the collision of the vehicle is sensed by the collision recognizing sensor, the inflator 6 is inflated by the collision signal of the collision recognizing signal to discharge the gas and the gas of the inflator 6 moves along the air bag housing 4 and floats to the inside of the cushion 20 through the holes of the retainer 8 so that the cushion 20 is deployed then, the cushion 20 Cuts off the cutting line 2A formed in the instrument panel 2 and deploys forward the passenger in the passenger seat to absorb the shock applied to the rider.

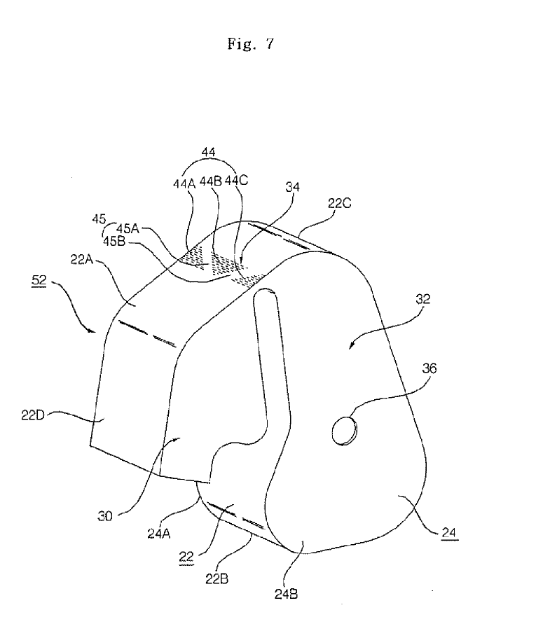

As illustrated in FIGS. 7A to 3, the cushion 20 according to an embodiment of the present invention includes a first cushion 30 fixed to the inside of the air bag housing 4 by the retainer 8 and having a gas inlet into which the gas of the inflator 6 is flown, a second cushion 32 formed in front of the first cushion 30 to receive the gas from the first cushion 30 and to deploy toward a rider, and a cushion connecting unit 34 formed between the second cushion 32 and the first cushion 30 so that the second cushion 32 is rotatably connected to the first cushion 30 and that the gas of the first cushion 30 floats into the second cushion 32.

The first and second cushions 30 and 32 are formed to have enough sizes so that the loads of the riders can be effectively absorbed after the riders are settled during the collision of the vehicle.

A vent hole is not formed in the first cushion 30. However, vent holes 36 for discharging the gas are formed on both sides of the second cushion 32.

That is, the vent holes 36 are formed in the pair of side panels 24 that form the left side and the right side of the cushion 20 to prevent the internal pressure of the second cushion 32 from excessively increasing and to expedite the relaxation of the second cushion 32 so that the performance of absorbing the shock applied to the riders is improved.

The cushion connecting unit 34 is integrated between the first and second cushions 30 and 32 by sewing a part of at least one panel of the main panel 22 and the side panels 24 that form the intermediate part of the cushion 20.

That is, the cushion connecting unit 34 includes a sewing unit 40 for sewing the center of the intermediate part of the upper part 22A and the lower part 22B and orifice units 41 composed of the upper part 22A, the lower part 22B, the left part 24A, and the right part 24B to function as gas floating paths on the left and right sides of the sewing unit 40.

The cushion connecting unit 34 is formed to be very narrow between the first and second cushions 30 and 32 by the sewing unit 40 to Support the second cushion 32 to be rotatable up and down The gas floating paths of a predetermined size are formed by the orifice units 41 in the parts excluding the sewing unit 40 to guide the gas in the first cushion 30 to the inside of the second cushion 32.

Therefore, when the length from side to side of the sewing unit 40 is controlled according to the designing conditions of the air hag system, the size of the orifice units 41 is controlled so that the deployment time and speed of the second cushion 32 are controlled.

As illustrated in FIGS. 2A to 2C, the cushion connecting unit 34 can be provided in the upper, lower and intermediate parts of the first and second cushions 30 and 32 according to the designing conditions of the air bag system.

That is, the cushion 20 of FIG. 2A is bent so that the intermediate part of the lower part 22D protrudes upward to be attached to the intermediate part of the upper part 22C. The sewing unit 40 is formed in the intermediate parts of the attached parts of the lower part 22D and the upper part 22C so that the cushion connecting unit 34 is provided on the first and second cushions 30 and 32. The cushion 20′ of FIG. 2B is bent so that the intermediate part of the upper part 22C of the main panel 22 protrudes downward to be attached to the intermediate part of the lower part 22D. The sewing unit 40 is formed in the intermediate parts of the attached parts of the lower part 22D and the upper part 22C so that the cushion connecting unit 34 is provided under the first and second cushions 30 and 32. The cushion 20″ of FIG. 2C is bent so that the upper part 22C and the lower part 22D of the main panel 22 protrude downward and upward, respectively, to be attached to each other and the attached parts of the tower parts 22D and the upper parts 22C are partially sewed so that the cushion connecting unit 34 is formed in the center between the first and second cushions 30 and 32.

Hereinafter, according to the present embodiment as illustrated in FIG. 2A, it will be described that the cushion connecting unit 34 is formed on the first and second cushions 30 and 32.

As described above, since the first cushion 30, the second cushion 32, and the cushion connecting unit 34 are formed by a simple method of sewing the intermediate part between the upper part 22C and the lower part 22D, it is possible to make the structure of the cushion 20 simple and it is not necessary to add additional parts in order to separate the cushion 20 into two chambers.

The operation and the effect of the passenger seat air hag system according to the present invention having the above structure will be described as follows.

First, when the collision recognizing sensor recognizes the collision of the vehicle to transmit the operation signal to the inflator 6, the inflator 6 is inflated to generate the gas and the generated gas moves along the air bag housing 4 and floats to the gas inlet of the cushion 20 through the holes of the retainer 8 so that the gas is flown into the inside of the cushion 20 through the gas inlet.

The first cushion 30 of the cushion 20 is first deployed by the gas and the first cushion 30 cuts off the cutting line 2A of the instrument panel 2 and is deployed forward the passenger seated in the passenger seat.

Then, when the first cushion 30 is completely deployed, the gas in the first cushion 30 floats into the second cushion 32 through the orifice units 41 of the cushion connecting unit 34 so that the second cushion 32 is deployed.

When the cushion 20 is not deployed once but is deployed in two steps as described above, a performance of protecting a rider in a normal position of the air bag system as well as a performance of protecting a rider in an out-of-position (OOP) of the air bag system is secured enough.

That is, since only the first cushion 30 is deployed at an initial stage of deploying the cushion 20, it is possible to protect the rider although the rider is in the OOP state where the rider is abnormally seated in a seat of a vehicle and to prevent the rider from being more injured by the deployment pressure of the cushion 20.

On the other hand, since the second cushion 32 deploys and the second cushion 32 is rotatably connected about the cushion connecting unit 34 in a state where the first cushion 30 deploys at the last state where the cushion 20 is deployed, it is possible to protect the rider in the normal position state like the conventional cushion and to prevent the rider in the OOP state from being pressed downward while the second cushion 32 rotating up and down so that it is possible to prevent the rider from being injured.

In particular, there is a regulation on the safety of the rider in the OOP state in the performance regulations of the air bag system. There is an injury reduction deployment test when a one year old child is seated in a child seat in the OOP state and an injury reduction deployment test when a three year old child and a six year old child are seated in children seats in the OOP states.

The injury reduction deployment tests for the three year old child and the six year old child are divided into a case in which the chests of the children are placed on the side of the instrument panel 2 and a case in which the heads of the children are placed on the side of the instrument panel 2.

In the case where the chests of the three year old child and the six year old child are placed on the side of the instrument panel 2, there is a large chance that the children are injured by the initial deployment pressure of the cushion. However, when the first cushion 30 and the second cushion 32 are deployed in steps like the cushion 20 according to the present invention, the deployment pressure transmitted to the children at the initial stage of the deployment of the cushion 20 is reduced so that it is possible to prevent the three year old child and the six year old child from being injured.

In the case of the three year old child and the six year old child whose heads are placed on the side of the instrument panel 2 and of the one year old child who is in the child seat, since the heads and the child seat are placed lower than the direction in which the cushion 20 deploys, the heads of the children and the child seat are pressed downward by the deployment pressure of the cushion 20 so that a large accident happens. However, when the second cushion 32 is connected to the first cushion 30 to be rotatable up and down like the cushion 20 according to the present invention, although the second cushion 32 deploys to press the heads of the children and the child seat downward, the second cushion 32 rotates about the cushion connecting unit 34 so that the pressing load is reduced and that it is possible to prevent the three year old child, the six year old child, and the one year old child from being injured.

Therefore, since the air bag system including the cushion 20 according to the present invention satisfies the test of the performance of protecting the rider in the OOP state, it is free from the restrictions of the respective countries for the air bag system.

When a rider who does not wear a safety belt is attached by the shock of a vehicle in a state where the first and second cushions 30 and 32 are completely deployed, the second cushion 32 absorbs the shock applied to the rider while discharging the gas through the vent holes 36. However, since the vent holes 36 are not formed in the first cushion 30 so that the gas is not discharged to the outside, it is possible to prevent the rider from being directly colliding with the instrument panel 2 due to the lack of the gas and to thus prevent the rider from being injured.

As described above, at the initial state of the deployment of the cushion 20, the first cushion 30 absorbs the shock applied to the rider. However, at the last stage where the cushion 20 is deployed, the rider collides with the instrument panel 2 due to the first cushion 30.

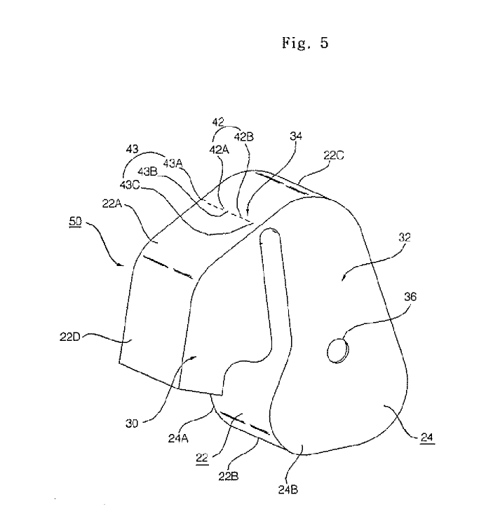

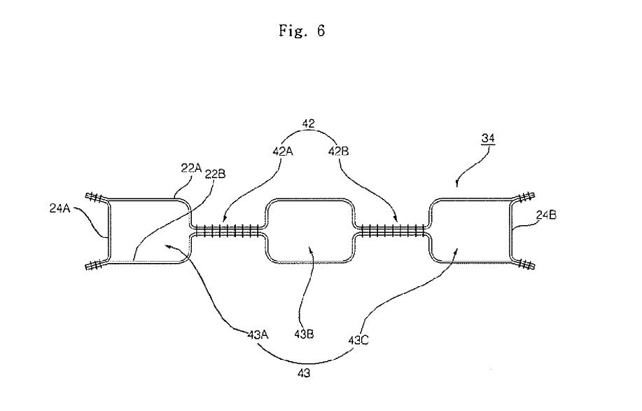

FIG. 5 is a perspective view illustrating a cushion of a passenger seat air bag system according to another embodiment of the present invention. FIG. 6 is a sectional view illustrating the cushion connecting unit of FIG. 5.

The same reference numerals in different drawings represent the same elements and thus their description will be omitted.

As illustrated in FIGS. 5 and 6, a cushion 50 according to another embodiment of the present invention includes a plurality of sewing units 42 of the cushion connecting unit 34 separated from each other between the first and second cushions 30 and 32 from side to side and orifice units 43 formed between the plurality of sewing units 42. The other elements are the same as those of the above-described embodiment of the present invention.

That is, the plurality of sewing units 42 are formed to be separated from each other in the intermediate part between the upper part 22C and the lower part 22D of the main panel 22 of the cushion 50 from side to side. When the number of sewing units 42 and the positions of the sewing units 42 are controlled in accordance with the designing conditions of the air bag system, the number of orifice units 43 and the positions of the orifice units are controlled.

In FIGS. 5 and 6, the two sewing units 42A and 42B are formed to be separated from each other from side to side so that the orifice units 43A, 43B, and 43C are formed on the left, on the right, and in the center of the cushion connecting unit 34. However, the present embodiment is not limited to the above but the number of sewing units 42 and orifice units 43 and the positions of the sewing units 42 and the orifice units 43 can vary in accordance with the designing conditions of the air bag system.

Therefore, unlike in the above-described embodiment of the present invention, since the flux or the gas flown into the second cushion 32 through the cushion connecting unit 34 is controlled in accordance with the designing conditions of the air bag system, the deployment time and speed of the second cushion 32 are controlled. Also, since the orifice units 43 are formed in the center of the cushion connecting unit 34, the gas is uniformly flown into the second cushion 32.

FIG. 7 is a perspective view illustrating a cushion of a passenger seat air bag system according to still another embodiment of the present invention.

The sane reference numerals in different drawings represent the same element, and thus their description will be omitted.

As illustrated in FIG. 7, a cushion 52 according to still another embodiment of the present invention includes a plurality of sewing units 44 of the cushion connecting unit 34 separated from each other between the first and second cushions 30 and 32 from side to side and back and forth and orifice units 45 formed between the plurality of sewing units 44 to be longitudinal back and forth. The other elements are the same as those of the above-described embodiment of the present invention.

That is, since the plurality of sewing units 44A, 44B, and 44C are formed to be separated from each other in the intermediate part between the upper part 22C and the lower part 22D of the main panel 22 of the cushion 52 from side to side, the orifice units 45A and 4513 are formed between the plurality of sewing units 44.

The plurality of sewing units 44 are formed to be separated from each other in the intermediate part between the upper part 22C and the lower part 22D back and forth so that the plurality of orifice units 45 are longitudinally formed in a specific direction.

The number of sewing units 44 and the positions of the sewing units 44 are controlled in accordance with the designing conditions of the air bag system so that the number of orifice units 45 and the position s of the orifice units 45 are controlled.

Therefore, unlike in the above-described embodiment of the present invention, since the flux of the gas flown into the second cushion 32 through the cushion connecting unit 34 is controlled in accordance with the designing conditions of the air bag system, the deployment time and speed of the second cushion 32 are controlled Also since the positions and the directions of the orifice units 45 formed in the cushion connecting unit 34 are controlled so that it is possible to optimize the direction in which the gas flown into the second cushion 32 floats.

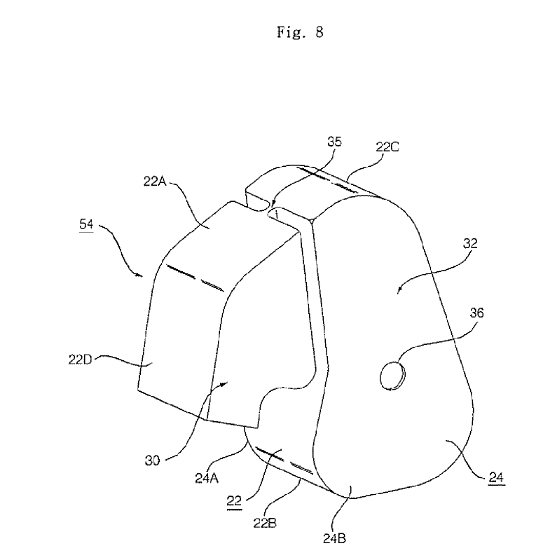

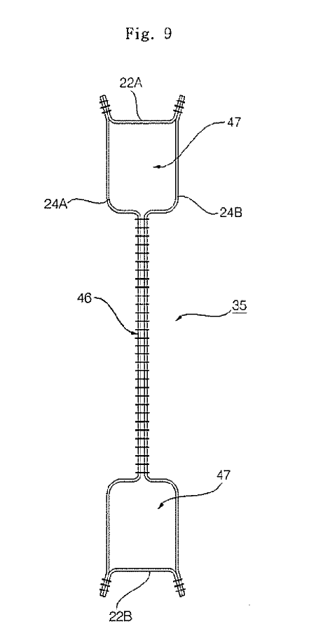

FIG. 8 is a perspective view illustrating a cushion of a passenger seat air bag system according to still another embodiment of the present invention. FIG. 9 is a sectional view illustrating the cushion connecting unit of FIG. 8.

The same reference numerals in different drawings represent the same element, and thus their description will be omitted.

As illustrated in FIGS. 8 and 9, in a cushion 54 according to still another embodiment of the present invention, a cushion connecting unit 35 includes a sewing unit 46 for sewing the center of the intermediate part of the left part 24A and the right part 24B and orifice units 47 composed of the upper part 22A, the lower part 22B, the left part 24A, and the right part 24B to function as gas floating paths on the upper and lower sides of the sewing unit 46. The other elements are the same as those of the above-described embodiment of the present invention.

That is, the cushion connecting unit 35 is formed to be very narrow between the first and second cushions 30 and 32 by the sewing unit 46 to support the second cushion 32 to be rotatable from side to side. The orifice units 47 are formed on and under the sewing unit 46, respectively, so that the second cushion 32 can smoothly deploy up and down.

While this invention has been particularly shown and described with reference to preferred embodiments thereof, it will be understood by those skilled in the art that various changes in form and details may be made therein without departing from the spirit and scope of the invention as defined by the appended claims.

That is, the cushion according to the present invention can be applied to a driver's seat air bag system and to a side air bag system as well as the passenger seat air bag system according to the embodiments.

The tether for controlling the deployment of the cushion can be provided in the cushion according to the present invention.

In the cushion of the air bag system according to the present invention having the above structure and comprised of the first and second cushions and the cushion connecting unit, since the first cushion is first deployed and then, the second cushion is deployed, it is possible to prevent the rider in the OOP state from being injured and to secure the performance of protecting the rider in the normal position state.

Also, since the first and second cushions are deployed in steps and the second cushion is rotatably connected to the first cushion by the cushion connecting unit, during the test of the performance of protecting the one year old child, the three year old child, and the six year old child in the OOP state of the air bag system, the injury reduction deployment of the Cushion is satisfied.

Also, when the performance of protecting the riders in the OOP state and in the normal position state is satisfied by the cushion, since the passenger recognizing sensor and the plurality of flaps that were adopted to the conventional air bag system are omitted, it is possible to reduce the number, the cost, and the weight of parts of the air bag system.

Also, since the first and second cushions are deployed in steps, the designing pressure of the inflator is reduced so that the capacity of the inflator is reduced.

1. A cushion of an air bag system comprising:
a first cushion deployable by a gas of an inflator;
a second cushion formed in front of the first cushion to receive the gas from the first cushion and to deploy toward a rider; and
a cushion connecting unit formed between the second cushion and the first cushion so that the second cushion is rotatably connected to the first cushion and that the internal gas of the first cushion flows into the second cushion.

2. The cushion of the air bag system as claimed in claim 1, wherein vent holes to discharge a gas to the outside are provided on both sides of the second cushion.

3. The cushion of the air bag system as claimed in claim 1, wherein the first and second cushions and the cushion connecting unit are integrated with each other.

4. The cushion of the air bag system as claimed in claim 3, wherein the cushion connecting unit is formed by partially sewing the connecting part of the first and second cushions.

5. The cushion of the air bag system as claimed in claim 4, wherein gas floating paths whose sections are narrower than the sections of the first and second cushions are formed in the parts that are not sewed in the cushion connecting unit.

6. The cushion of the air bag system as claimed in claim 5, wherein vent holes to discharge a gas to the outside are provided on both sides of the second cushion.

7. The cushion of the air bag system as claimed in claim 1, wherein the cushion comprises:
a main panel that forms a front part, the a rear part, an upper part, and the a lower part of the cushion; and
a pair of side panels connected to the main panel to form a left side and a right side of the cushion,
wherein the cushion connecting unit is formed by partially sewing at least one panel of the intermediate parts of the main panel and the side panels.

8. The cushion of the air bag system as claimed in claim 7, wherein the cushion connecting unit comprises:
sewing units that sew one side of the intermediate part between the upper part and the lower part; and
orifice units formed on sides of the intermediate part between the upper part and the lower part to function as gas floating paths.

9. The cushion of the air bag system as claimed in claim 8,
wherein the plurality of sewing units are provided from side to side, and
wherein the orifice units are formed between the plurality of sewing units.

10. The cushion of the air bag system as claimed in claim 8,
wherein the plurality of sewing units extend in a back to forward direction, and
wherein the orifice units are formed longitudinally by the plurality of sewing units so that the orifice units extend in a back to forward direction.

11. The cushion of the air bag system as claimed in claim 8,
wherein the intermediate part of the lower part is bent to protrude upward to be attached to the intermediate part of the upper part, and
wherein the sewing parts are provided in the attached parts of the upper part and the lower part.

12. The cushion of the air bag system as claimed in claim 8,
wherein the intermediate part of the upper part is bent to protrude downward to be attached to the intermediate part of the lower part, and
wherein the sewing parts are provided in the attached parts of the upper part and the lower part.

13. The cushion of the air bag system as claimed in claim 8,
wherein the intermediate parts of the upper part and the lower part are bent, respectively, to protrude downward and upward to be attached to each other, and
wherein the sewing parts are provided in the attached parts of the upper part and the lower part.

14. The cushion of the air bag system as claimed in claim 8, further comprising vent holes to discharge a gas to the outside are provided on both sides of the second cushion.

15. The cushion of the air bag system as claimed in claim 7, wherein the cushion connecting unit comprises:
sewing units that sew one side of the intermediate part between the left part and the right part; and
orifice units formed on the other side of the intermediate part between the left part and the right part to function as gas floating paths.

16. The cushion of the air bag system as claimed in claim 15,
wherein the plurality of sewing units are provided up and down, and
wherein the orifice units are formed between the plurality of sewing units.

17. The cushion of the air bag system as claimed in claim 15,
wherein the plurality of sewing units extend in a back to forward direction, and
wherein the orifice units are formed longitudinally by the plurality of sewing units so that the orifice units extend in a back to forward direction.

18. The cushion of the air bag system as claimed in claim 15, wherein vent holes to discharge a gas to the outside are provided on both sides of the second cushion.
